(19) United States
(12) Patent Application Publication
(10) Pub. No.: US 2011/0054660 A1
(43) Pub. Date: Mar. 3, 2011

(54) APPARATUS AND METHOD

(76) Inventors: Wolfgang Kiesler, Hohenollen (DE); Thomas Haebel, Obertshausen (DE)

(21) Appl. No.: 12/450,720

(22) PCT Filed: Apr. 10, 2008
(86) PCT No.: PCT/GB2008/054376

§ 371 Date: Nov. 12, 2010

(30) Foreign Application Priority Data
Apr. 12, 2007 (GB) 0707062.6

(51) Int. Cl. G06F 17/00; G05B 11/01

(52) U.S. Cl. 700/110; 700/11; 700/90; 700/21; 700/117; 700/108

(57) ABSTRACT

A machine comprising a first member (12), a second member (40) movable relative to the first member (12), a servo motor (36) for driving the second member (40), a logic controller (38) for controlling the servo motor (36), one or more inputs to the logic controller, the or each input being for transporting operational data, a storage device for storing the operational data, and an interface (50) to the storage device, the interface (50) being for providing access to the operational data. The system is for a form-fill-seal packaging machine comprising the logic controller (38).

This invention relates to apparatuses and methods for obtaining, storing and providing access to operational data.

International Patent Application Publication WO/2006/117539A discloses a machine for handling partially formed containers, which comprises an indexing conveying device, a feeder arranged to supply to the conveying device, per index, a plurality of partially formed containers, one or more stations comprising a plurality of devices arranged to perform substantially identical operations on a group of containers constituted by the plurality of partially formed containers, the indexing conveying device being arranged to advance the group through the stations, and a controlling device arranged to cause the feeder to reduce to an integer the number of partially formed containers supplied, per index, to the conveying device.

The machine is operated by the controlling device via a number of servomechanisms associated with each of the operations carried out by the machine. One of the servomechanisms is used for homing a moving mechanical part of the machine, a servo motor driving the moving mechanical part, the controlling device controlling the servo motor, and a mechanical stop for stopping the moving mechanical part at a home position, wherein the controlling device is arranged to monitor servo motor power draw and to recognise the home position as corresponding to a position of the servo motor when the servo motor power draw reaches a predetermined value.

The machine of this Publication provides a control device that monitors servo motor power draw, but in situations such as machine failure, the machine must be stopped, and no data is readily available from the control device.

It is therefore an object of the invention to improve upon the known art.

According to a first aspect of the present invention, there is provided apparatus comprising a first member, a second member movable relative to said first member, a servo motor for driving said second member, a logic controller for controlling said servo motor, one or more inputs to said logic controller, the or each input being for transporting operational data, a storage device for storing said operational data, and an interface to said storage device, said interface being for providing access to said operational data.

According to a second aspect of the present invention, there is provided a method comprising operating a servo motor to generate relative movement between a first member and a second member, controlling said servo motor with a logic controller, receiving operational data at said logic controller, storing said operational data at a storage device, and providing access to said operational data via an interface.

According to a third aspect of the present invention, there is provided a form-fill-seal packaging machine comprising a logic controller for controlling a component of said machine, one or more inputs to said logic controller, the or each input being for transporting operational data, a storage device for storing said operational data, and an interface to said storage device, said interface being for providing access to said operational data.

According to a fourth aspect of the present invention, there is provided a method comprising forming a partially formed container, filling said partially formed container, sealing said partially formed container, controlling a component with a logic controller, receiving operational data at said logic controller, storing said operational data at a storage device, and providing access to said operational data via an interface.

Owing to the invention, it is possible to provide and operate apparatus such that operational data is continually acquired and stored while the apparatus is functioning. Access to the operational data is possible while the apparatus is being used, which supports constant fault monitoring, which can be carried out remotely from the apparatus via the interface. At any time, a history of the operational parameters and performance, of the apparatus, is available, and this can be monitored in real time to anticipate faults.

Embodiments of the present invention will now be described, by way of example only, with reference to the accompanying drawings, in which:—

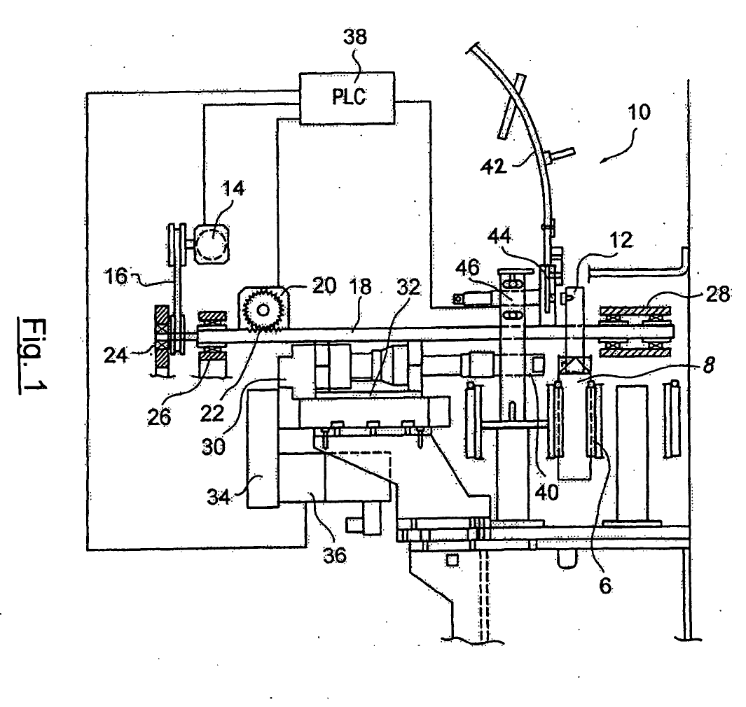

FIG. 1 is a partly diagrammatic, fragmentary, sectional, end elevation of a fitment-applying station of a form-fill-seal packaging machine, and

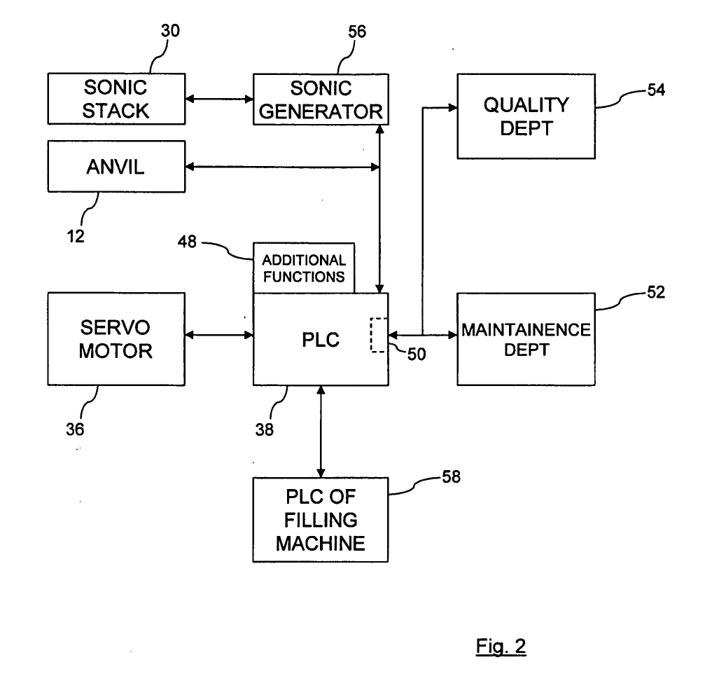

FIG. 2 is a schematic diagram of components of the machine of FIG. 1.

FIG. 1 shows a fitment-applying station 10 for use as part of a form-fill-seal packaging machine. The station 10 can be used to apply pour-spout fitments to cartons used to package liquid food products such as milk or fruit juice. The cartons are made of a laminate comprised of a paperboard substrate and innermost and outermost layers of moisture barrier thermoplastics, possibly with an oxygen barrier layer of aluminium or thermoplastics being interposed between the substrate and the innermost layer. Endless chain conveyors 6 index open-topped, bottom-sealed carton sleeves 8 through various stations of the machine including the fitment-applying station 10.

In FIG. 1, a first member providing an anvil is in the form of a rotary, four-armed spider 12 which is reciprocable horizontally and rotatable about its own axis. This form of spider is known, for example, from an Elopak® P-S120UC machine described in PCT/GB2006/003722. The spider 12 is rotated by an electric, rotary servomotor 14 through a transmission 16 in the form of a belt-and-pulley transmission whereby a horizontal shaft 18 to which the spider 12 is fixed is steppingly rotated about its own axis.

An electric rotary servomotor 20, controlled so as to rotate oscillatingly, reciprocates the shaft 18 through a rack-and-pinion arrangement 22. The shaft 18 is supported in bearings 24, 26 and 28 permitting both rotation and reciprocation of the shaft 18. An ultrasonic stack 30 is mounted upon a horizontal slide 32, itself reciprocated axially by a drive 34 including an electric rotary servomotor 36.

A programmable logic controller (PLC) 38 controls various items of the applicator 10, such as the servomotors 14, 20 and 36. For example, the power output of the servomotor 36 is controlled by the PLC 38 in such a manner as to ensure that the force applied by a second member, a horn 40, to the external surface of the carton 8, backed up by the anvil 12, does not exceed the predetermined, desired value stored by the PLC 38. The operation of the logic controller 38 is described in more detail below, with reference to FIG. 2.

When the applicator 10 operates, one or more pour spout fitments are received on the anvil 12 by actuating its linear drive to move the anvil 12 from its retracted position to its retrieval position, where the anvil 12 receives a fitment from a supply track escapement. A pair of fitment-delivering, gravity tracks 42 with respective escapements 44 having respective, pneumatic piston-and-cylinder ejectors 46 provide the pour spout fitments. The linear drive is then actuated to move the anvil 12 from the retrieval position to the retracted position. The anvil pivot drive is then actuated to pivot the anvil 12 from the retracted position to the inserted position, transporting the fitment downward into the open top of the carton 8.

The linear anvil drive is then actuated to move the anvil 12 from the retracted position to the mount position, causing the anvil 12 to insert a cylindrical portion of the fitment into the through-hole in a carton wall until a circumferential flange of the fitment contacts an inner surface of a portion of the carton wall that surrounds the through-hole, arresting anvil movement.

At or about the same time that the linear anvil drive is moving the flange of the fitment into contact with the inner surface of the carton wall, the horn drive 34 is actuated to move the ultrasonic horn 40 from its retracted position to its weld position, with the horn 40 contacting an outer surface of the portion of the carton wall surrounding the through-hole in the weld position. The horn 40 is then actuated to weld the fitment flange ultrasonically to the carton wall by transmitting ultrasonic energy into the carton wall and fitment flange when the ultrasonic horn 40 is in its weld position and the anvil 12 is in its mount position.

FIG. 2 shows in more detail the logic controller 38 in relation to the servo motor 36, which is the servo motor that, through the drive 34, reciprocates the ultrasonic stack 30. The stack 30 includes a horn 40 which acts against the anvil 12 when a pour spout fitment is applied to the carton 8. The logic controller 38 controls the operation of the servo motor 36 and receives back from that motor 36, and from other components in the station 10, operational data, which is stored by the logic controller 38. The logic controller 38 is provided with one or more inputs, the or each input being for transporting operational data. A storage device is provided, either internally or externally of the logic controller 38, for storing the operational data.

The operational data can include information such as the power drawn by the servo motor 36, performance data gathered from an ultrasonic generator 56 such as frequency variations, the resonance frequency, weld start and end frequencies, length of time of each weld, energy values, and power failures, and data gathered from monitoring devices such as a temperature sensor. The devices such as the temperature sensor provide their operational data to the logic controller 38 via a function unit 48. All of the operational data received by the logic controller 38 is continually stored, as the data is received at the various inputs to the logic controller 38. The operational data for every single weld undertaken by the station 10 is stored by the logic controller 38, providing full traceability.

The operational data can be monitored as it is received and can also be accessed by a suitable device remote from the station 10 through an interface 50 of the logic controller 38. For example, the logic controller 38 can be provided with a network interface 50 which can allow the controller 38 to be connected to the Internet. In this case a computer with the correct IP address and security access can, through the network interface 50 of the logic controller 38, access the operational data stored by the controller 38. The interface 50 is to the storage device (which is either internal or external to the logic controller 38), the interface 50 being for providing access to the operational data.

The interface 50 can include a filter to restrict the access of external devices to only a portion of the operational data stored by the logic controller 38. A maintenance department 52 and a quality control department 54 can be connected to the network interface 50, and the filter in the interface 50 can be so configured that each of these departments has access to different subsets of the operational data stored by the logic controller 38.

The logic controller 38 can be configured to monitor the operational data to perform real time fault monitoring. Each parameter, in the operational data monitored by the logic controller 38, can be assigned a fault tolerance from a predefined optimum value. The fault tolerance could be +/−3%, for example. The logic controller 38 can be configured to trigger a warning when the fault tolerance is exceeded on any of the parameters making up the operational data. This warning could be rendered locally or could be transmitted by the logic controller 38 to a remote device.

The tolerances can also be monitored to adjust the performance of the station 10, even if a fault is not specifically triggered. For example if one monitored parameter in the operational data is detected to be travelling away from its optimum value, yet not outside the tolerance boundary, adjustments to the operation of the components controlled by the logic controller 38 can be made to achieve the best possible working of the station 10.

Another fault that can be monitored by the logic controller 38 is the absence of either/or both of the carton 8 and the pour spout fitment that is to be attached to the carton 8. If, for any reason, there is no carton 8 and/or no pour spout fitment present, then the logic controller 38 can be configured to ensure that the ultrasonic stack 30 does not trigger. The functional unit 48 can be connected to a device that monitors for the presence of the necessary carton 8 and fitment and provides operational data to that effect to the logic controller 38.

The logic controller 38 can monitor the operational data for the purpose of adjusting the operation of components to which it is connected. For example, if the logic controller 38 were to receive operational data from a temperature sensor that indicates that the temperature at the region of the horn 40 is rising, then a change in the operational parameters of the ultrasonic stack 30 can be made in response. The ultrasonic sealing frequency can be changed to take into account the rise in temperature, thereby saving energy at the sonic stack 30.

The logic controller 38 can be provided with a user interface alternatively or in addition to the network interface 50. This local user interface can include a display device and keypad, for example. This allows on site monitoring of the operational data stored by the logic controller 38. Warnings generated by the logic controller 38 can also be presented via this user interface.

The user interface can also be utilised to select operating specifications such as the carton type and pour spout fitment configuration that are to be used in the station 10. The user selection of the operating specifications changes the predefined optimum parameters that are being controlled and monitored by the logic controller 38.

Other logic controllers within the form-fill-seal machine, such as a PLC 58 of a filling machine, are connected to the logic controller 38 of the station 10. Operational data can be shared between the various logic controllers, and performance monitoring, performance adaptation and fault warning can all include operational data acquired by multiple logic controllers. The interface 50 of the logic controller 38 can be used to access operational data stored by other logic controllers within the form-fill-seal packaging machine.

1-46. (canceled)

47. Apparatus comprising:
a first member;
a second member movable relative to said first member;
a servo motor for driving said second member;
a logic controller for controlling said servo motor;
one or more inputs to said logic controller, the or each input being for transporting operational data;
a storage device for storing said operational data; and
an interface to said storage device, said interface being for providing access to said operational data.

48. Apparatus according to claim 47, and further comprising an output from said servo motor, said output being connected to the or an input to said logic controller.

49. Apparatus according to claim 47, and further comprising an ultrasonic generator and an ultrasonic horn for emitting ultrasound, said logic controller being for controlling said ultrasonic generator.

50. Apparatus according to claim 49, wherein said second member includes said ultrasonic horn.

51. Apparatus according to claim 49, and further comprising an output from said ultrasonic generator, said output being connected to the or an input to said logic controller.

52. Apparatus according to claim 47, and further comprising a temperature sensor connected to the or an input to said logic controller.

53. Apparatus according to claim 47, wherein said logic controller is arranged to monitor said operational data, and to detect a fault in said operational data.

54. Apparatus according to claim 53, wherein said logic controller is arranged to detect a fault in said operational data if said operational data exceeds a predetermined tolerance.

55. Apparatus according to claim 53, wherein said logic controller is arranged, following detection of a fault, to transmit a fault signal to said interface.

56. Apparatus according to claim 47, wherein said logic controller is arranged to monitor said operational data, and accordingly to adapt the controlling of said servo motor.

57. A method comprising:
operating a servo motor to generate relative movement between a first member and a second member;
controlling said servo motor with a logic controller;
receiving operational data at said logic controller;
storing said operational data at a storage device; and
providing access to said operational data via an interface.

58. A method according to claim 57, and further comprising transmitting operational data from said servo motor to said logic controller.

59. A method according to claim 57, and further comprising operating an ultrasonic generator to emit ultrasound, and controlling said ultrasonic generator with said logic controller.

60. A method according to claim 59, and further comprising transmitting operational data from said ultrasonic generator to said logic controller.

61. A method according to claim 57, and further comprising operating a temperature sensor and transmitting operational data from said temperature sensor to said logic controller.

62. A method according to claim 57, and further comprising monitoring said operational data, and detecting a fault in said operational data.

63. A method according to claim 62, wherein said detecting a fault in said operational data comprises detecting that said operational data exceeds a predetermined tolerance.

64. A method according to claim 62, and further comprising, following detection of a fault, transmitting a fault signal.

65. A method according to claim 62, and further comprising monitoring said operational data, and accordingly adapting the controlling of said servo motor.

66. A form-fill-seal packaging machine comprising:
a logic controller for controlling a component of said machine;
one or more inputs to said logic controller, the or each input being for transporting operational data;
a storage device for storing said operational data; and
an interface to said storage device, said interface being for providing access to said operational data.

67. A machine according to claim 66, and further comprising a first member and a second member movable relative to said first member, wherein said component comprises a servo motor for driving said second member.

68. A machine according to claim 67, and further comprising an output from said servo motor, said output being connected to the or an input to said logic controller.

69. A machine according to claim 67, and further comprising an ultrasonic generator and an ultrasonic horn for radiating ultrasound, said logic controller being for controlling said ultrasonic generator, said second member including said ultrasonic horn.

70. A machine according to claim 66, and further comprising an ultrasonic generator and an ultrasonic horn for radiating ultrasound, said logic controller being for controlling said ultrasonic generator.

71. A machine according to claim 70, and further comprising an output from said ultrasonic generator, said output being connected to the or an input to said logic controller.

72. A machine according to claim 66, and further comprising a temperature sensor connected to the or an input to said logic controller.

73. A machine according to claim 66, wherein said logic controller is arranged to monitor said operational data, and to detect a fault in said operational data.

74. A machine according to claim 73, wherein said logic controller is arranged to detect a fault in said operational data if said operational data exceeds a predetermined tolerance.

75. A machine according to claim 73, wherein said logic controller is arranged, following detection of a fault, to transmit a fault signal to said interface.

76. A machine according to claim 67, wherein said logic controller is arranged to monitor said operational data, and accordingly to adapt the controlling of said servo motor.

77. A method comprising:
forming a partially formed container;
filling said partially formed container;
sealing said partially formed container;
controlling a component with a logic controller;
receiving operational data at said logic controller;
storing said operational data at a storage device; and
providing access to said operational data via an interface.

78. A method according to claim 77, wherein said component is a servo motor and further comprising operating said servo motor to generate relative movement between a first member and a second member.

79. A method according to claim 78, and further comprising transmitting operational data from said servo motor to said logic controller.

80. A method according to claim 78, and further comprising operating an ultrasonic generator to emit ultrasound, and controlling said ultrasonic generator with said logic controller.

81. A method according to claim 80, and further comprising transmitting operational data from said ultrasonic generator to said logic controller.

82. A method according to claim 77, and further comprising operating a temperature sensor and transmitting operational data from said temperature sensor to said logic controller.

83. A method according to claim 77, and further comprising monitoring said operational data, and detecting a fault in said operational data.

84. A method according to claim 83, wherein said detecting a fault in said operational data comprises detecting that said operational data exceeds a predetermined tolerance.

85. A method according to claim 83, and further comprising, following detection of a fault, transmitting a fault signal.

86. A method according to claim 77, and further comprising monitoring said operational data, and accordingly adapting the controlling of said servo motor.
